(19) United States
(12) Patent Application Publication
(10) Pub. No.: US 2003/0070163 A1
(43) Pub. Date: Apr. 10, 2003

(54) Method for distributing data in a data net

(75) Inventors: Erhard Kroesa, Fuerstenfeldbruck (DE); Werner Schneider, Munich (DE)

Correspondence Address: STAAS & HALSEY LLP, 700 11TH STREET, NW, SUITE 500, WASHINGTON, DC, 20001, US

(73) Assignee: Siemens AG, Munich (DE)

(21) Appl. No.: 10/264,325

(22) Filed: Oct. 4, 2002

(30) Foreign Application Priority Data
Oct. 4, 2001 (DE) 101 48 877.7

(51) Int. Cl. G06F 9/44

(52) U.S. Cl. 717/171; 717/170

(57) ABSTRACT

Data is distributed in a data network which incorporates data processing installations, at least some of which process data. The data are program packages and are distributed to appropriate data processing installations by at least one database server using database replication.

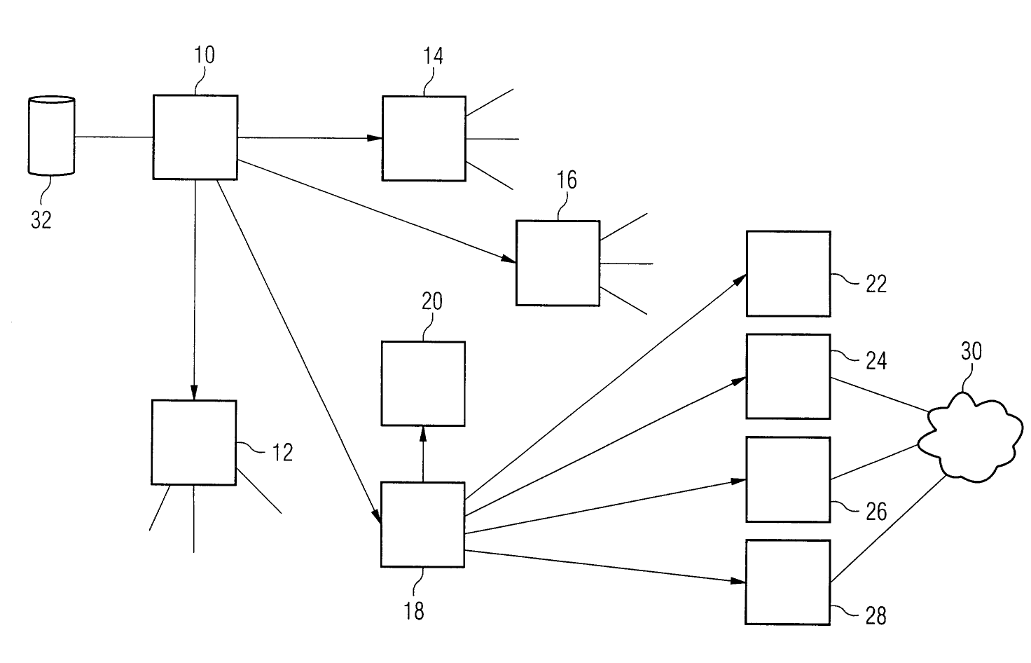

### CROSS REFERENCE TO RELATED APPLICATIONS

This application is based on and hereby claims priority to German Application No. 101 48 887.7 filed on Oct. 4, 2001, the contents of which are hereby incorporated by reference.

### BACKGROUND OF THE INVENTION

1. Field of the Invention

The invention relates to a method for distributing data in a data network.

2. Description of the Related Art

In a network of data processing installations—subsequently referred to as a data network—for example also in a network having computer-controlled exchanges or private branch exchanges, smooth operation of the data network frequently requires the software state of the individual data processing installations to be kept consistent. This is understood to mean, in particular, continual updating of the software used in the data network—for example using updates.

Database replication methods are known which are generally used to align ASCII data to one another within a distributed database system. By way of example, “Guide to Informix-Enterprise Replication”, Version 7.3, February 1998, Part No 000-4350 discloses such a database replication method.

Distributed database systems for ASCII data are frequently used in commerce. In this context, a central control station holds a database containing articles which are simultaneously also made available in branches. If the articles are updated in the central control station, then for the data state to be consistent it is necessary for this update to be carried out in the branches as well. In this case, the data to be aligned and transferred are generally pure ASCII data.

Data networks in which various data states may need to be aligned and transacted exist not only in commerce, but also in the telecommunication industry. Elements of modern telecommunication networks are generally software-assisted, i.e. they include computers which are specifically tailored to telecommunication applications and which execute programs for operating the elements. Such elements can, by way of example, be exchanges or private branch exchanges (PBX). To be able to ensure smooth operation of such a computer-assisted telecommunication network, care must be taken to ensure that the programs in the individual exchanges or private branch exchanges are always at a current software state.

The individual programs can be serviced manually only in relatively small data or telecommunication networks having few data processing installations or exchanges, including private branch exchanges. From a certain network size upward, however, such manual servicing is complex and therefore too expensive. To reduce this complexity and at the same time to reduce the cost, binary software data or program packages are therefore generally transferred to data processing or telecommunication installations by specifically provided servicing programs using a central distributor. The transaction of the binary program packages onto the data processing or telecommunication installations requires control which primarily ensures consistent, error-free and complete data transmission. Depending on the level of expansion of the data or telecommunication network, it is also necessary to change the servicing program which is specifically matched to the data processing or telecommunication installations and to the network.

A drawback of the aforementioned servicing programs is that they need to be started manually, that is to say individually. Generally, this is done by an administrator for the data or telecommunication network who is responsible for servicing the network software. The administrator's tasks include, inter alia, installing current software in a database, starting up the servicing program and monitoring the update procedure. Depending on the size of the network, such an update procedure can be very time-consuming. Such semi-automatic update procedures are therefore generally very expensive.

Another drawback of the known servicing programs for data and telecommunication networks is the lack of universal applicability. The servicing programs are highly specific to a particular network and, by way of example, to the structure thereof. Accordingly, any change in the network normally requires a complex adjustment to the servicing program.

### SUMMARY OF THE INVENTION

It is therefore an object of the present invention to specify a method for distributing data in a data network which firstly ensures that the software in the data network, more precisely in its data processing installations, is always up to date and which reduces the time required for updating the software. In addition, the intention is for it to be able to be used universally for any data networks.

An aspect of the invention to update program software in a data network using database replication mechanisms which are tried and tested and are widely used in the field of data processing. This makes use of the fact that the program software in a data network can frequently be regarded, in principle, as a distributed database. For distributed databases, there are many tried and tested replication mechanisms. By way of example, reference is made here to the replication mechanism from the company Informix Software, Inc. already mentioned above. It is known that replication in a distributed database management system is understood to mean copying the database or parts of the database to other areas in a network. Replication ensures the integrity of the distributed databases.

Specifically, the invention relates to a method for distributing data in a data network which incorporates a multiplicity of data processing installations and in which at least some of the data processing installations process the same data. The data are program packages and are distributed to the appropriate data processing installations by at least one database server using database replication mechanisms. This provides a relatively simple way of ensuring the integrity of the distributed program packages in the data network. Generally, the distribution of the program packages requires no manual intervention on account of the database replication mechanisms. Replication takes place fully automatically, as it were. This allows cost to be saved. The administrator of a data network is thus almost completely relieved of the time-consuming and cost-intensive task of distributing the program packages in the data network and of ensuring the integrity of the distributed program packages.

Another advantage is that such database replication mechanisms are available as software standard modules and can be installed in a data network, particularly on the at least one database server, relatively easily and inexpensively. Particularly the database replication mechanisms' incorporated methods of aligning program packages and of transaction control for the distribution have proved themselves in practice and provide a simple way of dealing with the otherwise time-consuming task of updating the stock of software in a data network.

Preferably, the program packages include binary files which are provided by the database server. Distribution of binary files does not require any further processing, particularly preparation for execution of the distributed program packages in the data processing installations themselves. Expressed in simple terms, the binary files can be used to update the software in a data network directly without any additional complexity.

Advantageously, the binary data to be updated, i.e. program packages, are transferred from the database server to the appropriate data processing installations in binary large objects or “blobs”. In this case, modern database replication mechanisms support replication of blob data in addition to the replication of ASCII data.

### BRIEF DESCRIPTION OF THE DRAWINGS

These and other objects and advantages of the present invention will become more apparent and more readily appreciated from the following description of the preferred embodiments, taken in conjunction with the accompanying drawing which is a block diagram of an exemplary embodiment of a telecommunication network having a central computer and local service computers used to distribute program packages to telecommunication installations.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In smaller data networks, the program packages can be distributed directly using a database server. In larger data networks having a multiplicity of data processing installations, however, it may be more beneficial to connect the database server to at least one local service computer. The local service computer is connected to at least one data processing installation for communication. The program packages are then distributed via the service computers, which represent intermediate stations, as it were. Seen in terms of a hierarchy, the distribution of the program packages starts on the database server and progresses via the service computers up to the individual data processing installations whose software or programs need to be updated.

In an embodiment of the method which is particularly preferred at present, a database management system ensures the integrity of the distributed program packages by replication. In principle, the database management system represents a software level between a database and a user. It handles requests from the user for particular database actions and in so doing permits control of security and data integrity.

The database management system significantly simplifies the work of an administrator for the data network. The administrator can access the stock of software in the data network using the database management system, by dint of which he uses a standard, for example graphical, user interface in order to control access to the stock of software in the data network. The user can therefore use the database management system as an easy way of installing updated program packages in the database for distribution in the data network and of starting a largely fully automatic updating procedure in the data network manually.

Preferably, the database management system is distributed over the at least one database server and the local service computers. In this case, the database management system represents a distributed database. This significantly extends the total power of the database. Such a system can also easily service very large data networks having several thousand data processing installations.

As already mentioned, the database server can have a database which includes current versions of the program packages and from which program packages are loaded during replication.

The inventive method can be used particularly advantageously in telecommunication networks. In this case, at least some of the data processing installations are computer-assisted telecommunication installations which execute the program packages. Such computer-assisted telecommunication installations are customary today in modern telecommunication networks. By way of example, these telecommunication installations can be exchanges or private branch exchanges. In such a case, the program packages are preferably parts of the operating software for the exchanges or private branch exchanges.

In the drawing, a central computer 10 is provided as a database server and is connected to four local service computers 12, 14, 16 and 18. The local service computers 12, 14, 16 and 18 are in turn connected to computer-controlled telecommunication installations, of which three telecommunication installations denoted by the reference numerals 24, 26 and 28 are shown by way of example. The telecommunication installations 24, 26 and 28 are connected firstly to the local service computer 18 and secondly to a telecommunication network 13, for example to a PSTN (Public Switched Telephone Network) or an ISDN (Integrated Services Digital Network). The connection of the other local service computers 12, 14 and 16 to further telecommunication installations (not shown) is indicated schematically.

As further elements in the telecommunication network, there are local servers 20 and 22 for data and programs, such as a (relational) database which is provided on the market by various providers. The servers 20, 22 are connected to the local service computer 18, i.e. the local service computer 18 can access the database. Program packages loaded from a database 32 by the central computer 10 are replicated via the local service computers 12, 14, 16 and 18. The program packages are in turn distributed to the telecommunication installations 24, 26 and 28 by the central service computers 12, 14, 16 and 18. In this context, database replication mechanisms ensure that the program packages are distributed largely without error.

In summary, the transaction controller contained in the aforementioned database replication mechanisms achieves error-free, fast and simple distribution of program packages in a telecommunication network essentially without manual intervention. This ultimately results in cost savings, since an administrator for the telecommunication network is relieved of the time-consuming work of distributing program packages and monitoring the distribution.

The invention has been described in detail with particular reference to preferred embodiments thereof and examples, but it will be understood that variations and modifications can be effected within the spirit and scope of the invention.

What is claimed is:

1. A method for distributing data in a data network of data processing installations, at least some of the data processing installations processing data, comprising:
distributing program packages to appropriate data processing installations by at least one database server using database replication.

2. The method as claimed in claim 1, further comprising ensuring integrity of the program packages by transaction control using a database management system.

3. The method as claimed in claim 2,
wherein the database server has a database which includes current versions of the program packages, and
wherein said distributing comprises loading the program packages from the database during replication.

4. The method as claimed in claim 2, wherein at least some of the data processing installations are computer-assisted telecommunication installations which execute the program packages.

5. The method as claimed in claim 2, wherein at least some of the computer-assisted telecommunication installations include at least one of exchanges and private branch exchanges.

6. The method as claimed in claim 2, wherein the program packages include binary files created by the database server.

7. The method as claimed in claim 6, wherein said distributing includes transmitting the binary files from the database server to the data processing installations in binary large objects.

8. The method as claimed in claim 2,
wherein the database server is connected to at least one local service computer which can communicate with at least one data processing installation,
wherein said distributing comprises distributing the program packages to each local service computer by the database server, and
wherein said method further comprises transmitting the program packages from each service computer to the data processing installations connected thereto.

9. The method as claimed in claim 8, wherein the database management system is distributed over the at least one database server and the local service computers.

10. The method as claimed in claim 1,
wherein the database server has a database which includes current versions of the program packages, and
wherein said distributing comprises loading the program packages from the database during replication.

11. The method as claimed in claim 1, wherein at least some of the data processing installations are computer-assisted telecommunication installations which execute the program packages.

12. The method as claimed in claim 1, wherein at least some of the computer-assisted telecommunication installations include at least one of exchanges and private branch exchanges.

13. The method as claimed in claim 1, wherein the program packages include binary files created by the database server.

14. The method as claimed in claim 13, wherein said distributing includes transmitting the binary files from the database server to the data processing installations in binary large objects.

15. The method as claimed in claim 1,
wherein the database server is connected to at least one local service computer which can communicate with at least one data processing installation,
wherein said distributing comprises distributing the program packages to each local service computer by the database server, and
wherein said method further comprises transmitting the program packages from each service computer to the data processing installations connected thereto.

16. The method as claimed in claim 1, wherein said distributing includes transmitting the binary files from the database server to the data processing installations in binary large objects.

17. A data network, comprising:
data processing installations, at least some of the data processing installations processing data; and
at least one database server, coupled to the data processing installations, to use database replication to distribute program packages to appropriate data processing installations.

18. At least one computer readable medium storing at least one program to control at least one processor to perform a method for distributing data in a data network of data processing installations, at least some of the data processing installations processing data, said method comprising:
distributing program packages to appropriate data processing installations by at least one database server using database replication.
